(19) United States
(12) Patent Application Publication
(10) Pub. No.: US 2008/0212939 A1
(43) Pub. Date: Sep. 4, 2008

(54) Communication apparatus

(75) Inventor: Yoshio Furuichi, Mitaka-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/899,132

(22) Filed: Sep. 4, 2007

(30) Foreign Application Priority Data
Dec. 8, 2006 (JP) 2006-332150

(51) Int. Cl. H04N 5/91

(52) U.S. Cl. 386/95

(57) ABSTRACT

A mobile terminal includes a storage unit which stores content data which contains sequential content, a playback unit which plays back the content data stored in the storage unit, and a control unit connected to the storage unit and the playback unit, and the control unit executes the following control. That is, when a playback restart request is issued for the interrupted content data, whether a synopsis needs to be played back is determined based on a predetermined synopsis playback condition. When it is determined that the synopsis needs to be played back, the playback unit plays back synopsis data corresponding to the content data before an interruption position, and plays back the content data from the interruption position.

### CROSS-REFERENCE TO RELATED APPLICATIONS

This application is based upon and claims the benefit of priority from prior Japanese Patent Application No. 2006-332150, filed Dec. 8, 2006, the entire contents of which are incorporated herein by reference.

### BACKGROUND OF THE INVENTION

1. Field of the Invention

The present invention relates to a communication apparatus such as a cellular phone or personal digital assistant (PDA) and, more particularly, to a mobile terminal having a function of playing back video and book content.

2. Description of the Related Art

Recently, many mobile terminals such as cellular phones and PDAs have a function of playing back music, video, and book content in addition to a speech communication function and a mail transmission/reception function. A conventional mobile terminal generally plays such content for a relatively short time, e.g., a few minutes. However, along with an increase in capacity of a battery, an improvement of performance of a codec, and an increase in capacity of a storage device, a recent mobile terminal has been developed for the purpose of playing content for several tens of minutes.

The mobile terminal often plays video content and the like in a recess or on the move on a train, and an incoming telephone call or a mail message is often received during playback. Hence, content playback is often interrupted. Upon interruption of content playback, if content playback is to be restarted, a user may forget the content before interruption.

To cope with this problem, for example, a technique has been proposed, which divides content into units, prepares and stores a synopsis for each unit, reads and plays back the synopsis corresponding to the unit having the content before interruption when content playback is to be restarted, and then plays back the content after the interruption position (e.g., see Jpn. Pat. Appln. KOKAI Publication No. 2005-025797).

However, if the recess or moving time is short or if many incoming calls are received, content playback is often interrupted, and the content is divided into small units. In such a case, if a synopsis is played back every time content playback is to be restarted, it is troublesome for the user, and an improvement has been required.

### BRIEF SUMMARY OF THE INVENTION

It is an object of the present invention to provide a mobile terminal which plays back a synopsis which is strongly required by a user when content playback is to be restarted after interruption, and improves the convenience of content playback.

In order to achieve the above object, according to an aspect of the present invention, there is provided a mobile terminal including a storage unit configured to store content data which contains sequential content, a playback unit configured to playback the content data stored in the storage unit, and a control unit connected to the storage unit and the playback unit, and the control unit executes the following control. That is, when a playback restart request is issued for the interrupted content data, whether a synopsis needs to be played back is determined based on a predetermined synopsis playback condition. When it is determined that the synopsis needs to be played back, the playback unit plays back synopsis data corresponding to the content data before the interruption position, and plays back the content data from the interruption position.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a schematic arrangement of a mobile terminal according to the first embodiment of the present invention;

FIG. 2 is a block diagram showing a functional arrangement of the control unit of the mobile terminal shown in FIG. 1;

FIG. 3 is a block diagram showing a functional arrangement of the storage unit of the mobile terminal shown in FIG. 1;

FIG. 4 is a flowchart showing the sequence and operations of content/synopsis data playback control of the control unit shown in FIG. 2;

FIG. 5 is a flowchart showing the sequence and operations of a synopsis playback determination process during playback control shown in FIG. 4;

FIG. 6 is a view showing examples of the content data and the synopsis data stored in the storage unit shown in FIG. 3;

FIG. 7 is a view for explaining the playback operation of the content data and the synopsis data in the mobile terminal according to the first embodiment of the present invention;

FIG. 8 is a view showing examples of the content data and the synopsis data stored in the storage unit of the mobile terminal according to the second embodiment of the present invention;

FIG. 9 is a view for explaining the playback operation of the content data and the synopsis data in the mobile terminal according to the second embodiment of the present invention;

FIG. 10 is a view showing examples of the content data and the synopsis data stored in the storage unit of the mobile terminal according to the third embodiment of the present invention;

FIG. 11 is a view for explaining the playback operation of the content data and the synopsis data in the mobile terminal according to the third embodiment of the present invention;

FIG. 12 is a view showing examples of the content data and the synopsis data stored in the storage unit of the mobile terminal according to the fourth embodiment of the present invention; and

FIG. 13 is a view for explaining the playback operation of the content data and the synopsis data in the mobile terminal according to the fourth embodiment of the present invention.

### DETAILED DESCRIPTION OF THE INVENTION

Embodiments of the present invention will be described below with reference to the accompanying drawing.

### First Embodiment

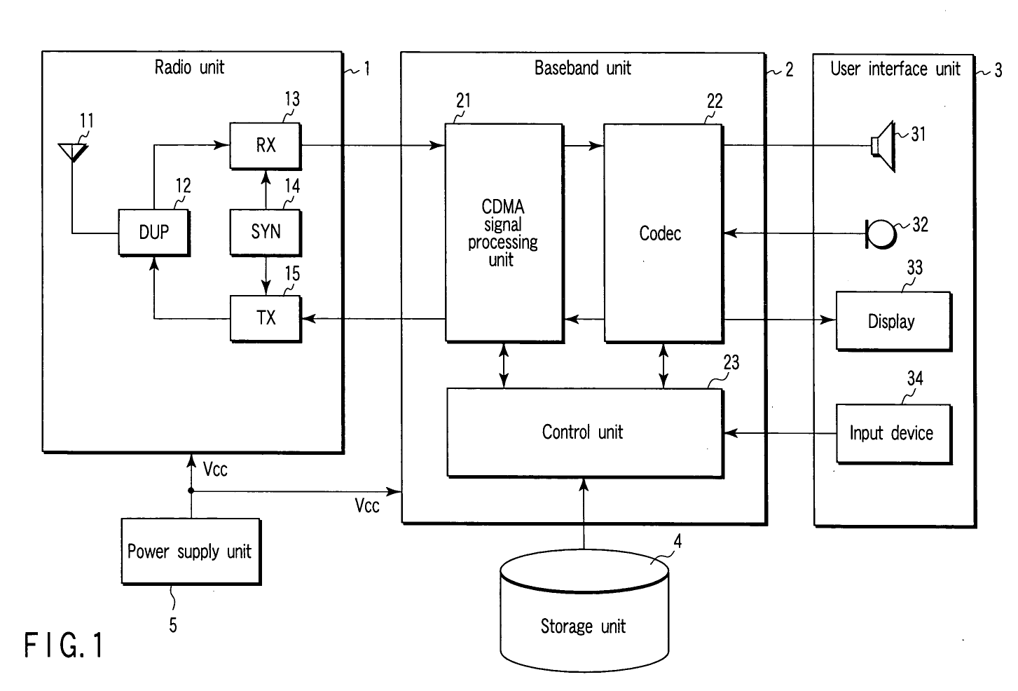

FIG. 1 is a block diagram showing an overall arrangement of a mobile terminal according to the first embodiment of the present invention. This mobile terminal includes a radio unit 1, baseband unit 2, user interface unit 3, storage unit 4, and power supply unit 5.

In the reception system of the radio unit 1, a radio signal transmitted from a base station (not shown) is received by an antenna 11, and guided to a receiving circuit (RX) 13 via a duplexer (DUP) 12. The receiving circuit 13 mixes the received radio signal with a reception local oscillation signal generated by a synthesizer (SYN) 14, thereby converting the signal into a reception baseband signal.

The baseband unit 2 includes a code division multiple access (CDMA) signal processing unit 21, encoding/decoding unit (to be referred to as a codec hereinafter) 22, and control unit 23. The CDMA signal processing unit 21 includes a RAKE receiver. The RAKE receiver despreads a plurality of passes included in the reception baseband signal by using spreading codes. The signals of these despread passes are combined after these signals become in phase with each other. In this manner, reception packet data having a predetermined transmission format is obtained.

The codec 22 demultiplexes the reception packet data obtained from the CDMA signal processing unit 21 for each medium by a demultiplexer, and decodes each demultiplexed media data. For example, if audio data is contained in the reception packet data, this audio data is decoded by a speech decoder. Also, if video data is contained in the reception packet data, this video data is decoded by a video decoder. In addition, if text data such as mail messages or downloaded data such as content is contained in the reception packet data, only an error correction decoding process is performed.

A digital audio signal obtained by the speech decoder is decoded, by PCM, by a pulse code modulation (PCM) decoder in the codec 22, and converted into an analog audio signal. This analog audio signal is amplified by a reception amplifier (not shown), and output as sound from a loudspeaker 31 of the user interface unit 3. A digital video signal is input from the codec 22 to the control unit 23. Text data such as mail messages or downloaded data such as content are also input to the control unit 23. The control unit 23 displays the digital video signal from the codec 22 on a display 33 of the user interface unit 3 via a video random access memory (RAM). Note that the storage unit 4 stores text data such as mail messages or downloaded data such as content.

A speech signal of a speaker input to a microphone 32 of the user interface unit 3 in the speech mode is amplified to an appropriate level by a transmission amplifier (not shown), and input to the codec 22 of the baseband unit 2. The codec 22 causes the PCM encoder to encode, by PCM, the input speech signal to convert the encoded signal into a digital audio signal, and the speech encoder encodes the obtained signal to compress a data amount. Also, a video signal captured by the camera (not shown) is input to the codec 22 via the control unit 23. The codec 22 causes the video encoder to encode the input video signal in order to compress the data amount. Note that text data such as mail messages generated by the control unit 23 is also input from the control unit 23 to the codec 22.

The codec 22 generates transmission packet data by packetizing the audio data encoded by the speech encoder, the video data encoded by the video encoder, and the text data such as mail messages according to a predetermined transmission format using a multiplexer/demultiplexer, and outputs this transmission packet data to the CDMA signal processing unit 21.

The CDMA signal processing unit 21 spreads the spectrum of the transmission packet data output from the codec 22 by using a spreading code assigned to a transmission channel, and outputs the output signal to a transmitting circuit (TX) 15 of the radio unit 1. The transmitting circuit 15 modulates the signal having the spread spectrum by using a digital modulation method such as quadrature phase shift keying (QPSK). The transmitting circuit 15 mixes the modulated transmission signal with the transmission local oscillation signal generated from the synthesizer 14, thereby converting the signal into a radio signal. Then, the transmitting circuit 15 amplifies the radio signal to a high frequency so that the transmission power level designated by the control unit 23 is obtained. The amplified radio signal is supplied to the antenna 11 via the duplexer 12, and transmitted from the antenna 11 to the base station.

The storage unit 4 uses, e.g., a hard disk or NAND flash memory as a storage medium, and includes a content storage area 41, synopsis storage area 42, and schedule storage area 43 as storage areas for storing data.

The content storage area 41 stores, e.g., video content data which is downloaded from a Web site or which is loaded from an external storage medium such as a memory card (not shown). The synopsis storage area 42 stores data representing the synopsis of video content data. The schedule storage area 43 stores information representing an action schedule input by the user at an input device 34.

Note that the video content data and the synopsis data may be generated as a single file, and downloaded to be stored. In this case, the video content data and the synopsis data may be stored in the same area, or stored in different areas in correspondence with each other.

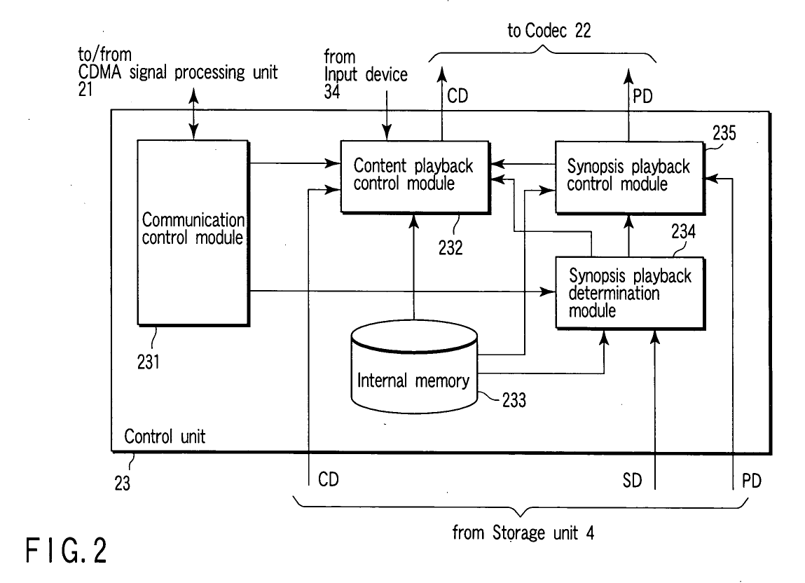

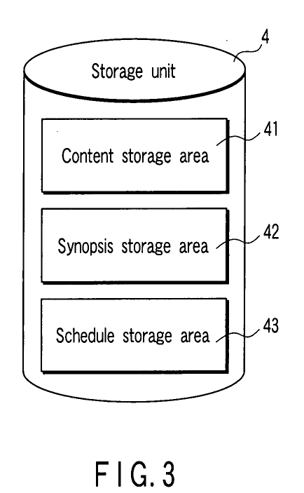

The control unit 23 includes a central processing unit (CPU), and has the following function modules as control functions according to the present invention. FIG. 2 is a block diagram showing the functional arrangement of the control unit 23. That is, the control unit 23 includes a communication control module 231, content playback control module 232, internal memory 233, synopsis playback determination module 234, and synopsis playback control module 235.

The communication control module 231 controls communication with the base station and a communication partner in accordance with a predetermined communication protocol in a speech communication mode, mail transmission/reception mode, and Web browsing mode. In this case, the communication control module 231 supplies an incoming call generation notification and a communication termination notification to the content playback control module 232 and the synopsis playback determination module 234, respectively.

If the user issues a content playback request via the input device 34, the content playback control module 232 reads corresponding content data from the content storage area 41 of the storage unit 4, and supplies the read content data to the codec 22 to playback it. During controlling playback for a content data, if the content playback control module 232 receives a notification for incoming call from the communication control module 231, the content playback control module 232 suspends content data playback control, and the content playback control module 232 control to store an interruption time and an interruption position of the content data in the internal memory 233.

Upon reception of the communication termination notification from the communication control module 231, the synopsis playback determination module 234 determines whether to playback the synopsis data based on a plurality of predetermined determination conditions. Upon determining that “synopsis data is to be played back”, the synopsis playback determination module 234 instructs the synopsis playback control module 235 to playback the synopsis. Upon determining that “synopsis data is not to be played back”, the synopsis playback determination module 234 instructs the content playback control module 232 to playback the content.

The following are five conditions to playback the synopsis data.

(1) The past playback record (e.g., the playback count) of interrupted content data is less than a threshold value.

(2) The elapsed time from the interruption time of interrupted content data is more than a threshold value.

(3) The degree of preference (rate information) of interrupted content data is less than a threshold value.

(4) Schedule data contains no event information of a user within a predetermined period of time in the future.

(5) The played back time of interrupted content data is less than a threshold value.

Note that one or a plurality of conditions (1) to (5) need to be satisfied.

If the synopsis playback determination module 234 determines that “synopsis is to be played back”, the synopsis playback control module 235 reads appropriate synopsis data from the synopsis storage area 42 of the storage unit 4 based on the interruption position stored in the internal memory 233, and supplies the read synopsis data to the codec 22 to playback it. After completion of playback of the synopsis data, the synopsis playback control module 235 instructs the content playback control module 232 to restart playback of content data.

Note that the power supply unit 5 has a battery. Based on the battery output, the power supply unit 5 generates an operation power supply voltage Vcc, and supplies it to the radio unit 1, baseband unit 2, user interface unit 3, and storage unit 4.

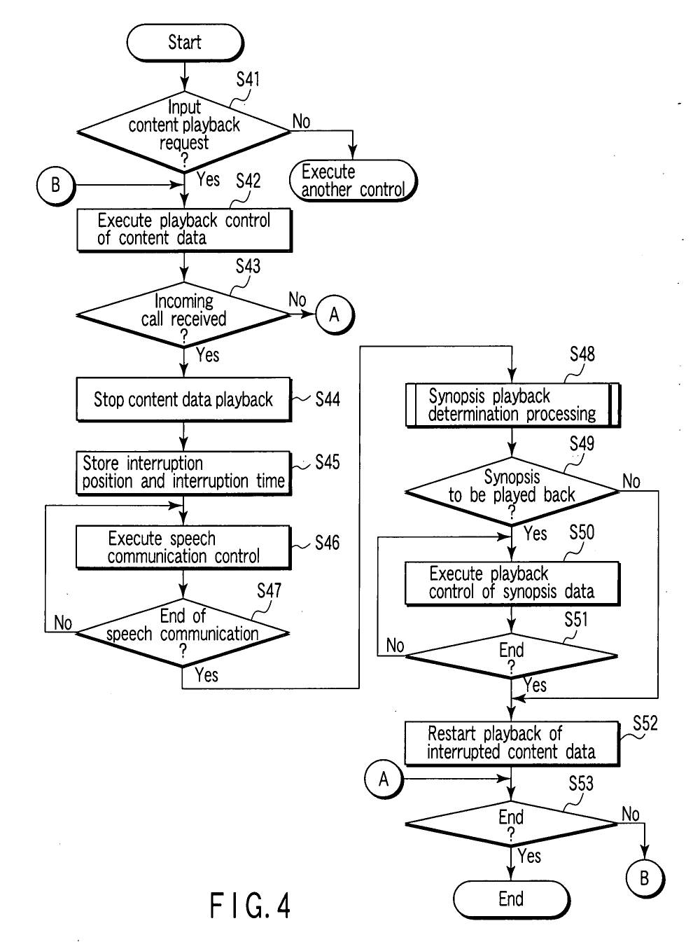

The content/synopsis data playback operation of the mobile terminal with the above-described arrangement will be described next. FIG. 4 is a flowchart showing the control sequence and control operations of this operation.

Content data is downloaded from a Web site, and stored by the control unit 23 in the content storage area 41 of the storage unit 4. At the same time, data representing the synopsis of the content data is also downloaded from the Web site, and stored by the control unit 23 in the synopsis storage area 42 of the storage unit 4. Also, information representing a user's action schedule is input by the user at the input device 34, and stored by the control unit 23 in the schedule storage area 43 of the storage unit 4.

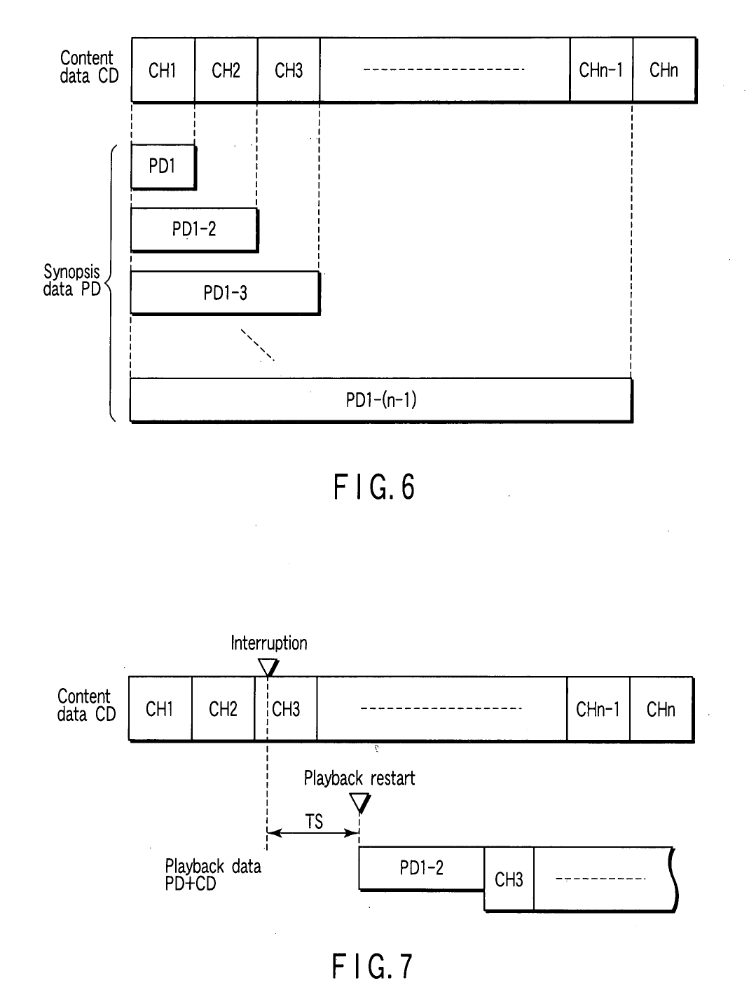

The synopsis data is generated by a content producer or on a Web site. For example, if a content data CD includes a plurality of chapters CH1 to CHn as shown in FIG. 6, the synopsis data comprises a plurality of data PD1, PD1-2, PD1-3, . . . , and PD1-(n−1) respectively representing synopsises of the content from the beginning of the content data CD to the end of the chapters CH1 to CHn−1. Note that the content data and synopsis data can be read from an external storage medium such as a memory card, and stored in the storage unit 4.

Assume that the user inputs a content playback request via the input device 34 in a standby state. In this case, the process advances from step S41 to step S42, and the control unit 23 plays back the content data under the control of the content playback control module 232. As a result, video content data designated by the playback request is read from the content storage area 41 of the storage unit 4. The codec 22 decodes video data contained in the video content data, and displays it on the display 33. The codec 22 also decodes audio data contained in the video content data, and outputs it from the loudspeaker 31.

During playback of the content data, the control unit 23 monitors termination of playback of the content data in step S53 while monitoring reception of an incoming call in step S43. When playback of the content data is terminated, the mobile terminal returns to a standby state. When the user executes a content playback termination operation, the control unit 23 also terminates playback control of the content data, and the mobile terminal returns to the standby state.

On the other hand, assume that an incoming call is received during playback of the content data. In this case, the process advances from step S43 to step S44, and the control unit 23 interrupts playback of the content data under the control of the content playback control module 232. In step S45, the control unit 23 acquires information representing the interruption time from an internal clock (not shown), stores the acquired information in the internal memory 233, and stores, in the internal memory 233, information representing the interruption position of the content data. When the above-described content interruption process ends, the process advances to step S46, and the control unit 23 executes speech communication under the control of the communication control module 231.

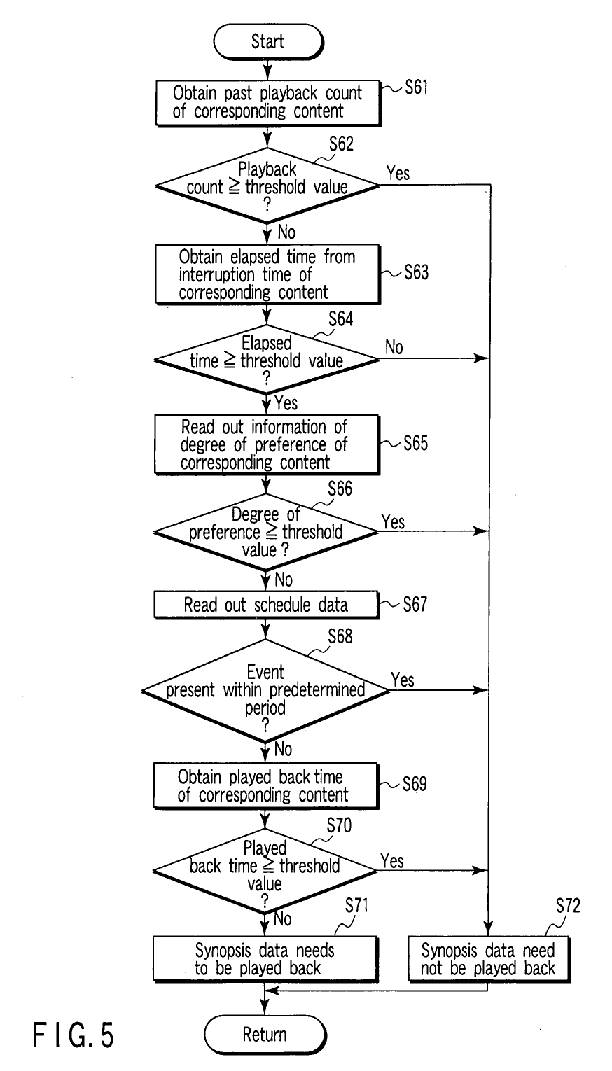

When the speech communication ends, the communication control module 231 supplies a communication termination notification to the synopsis playback determination module 234. Upon reception of this notification, the process advances from the step S47 to step S48, and the synopsis playback determination module 234 executes a process for determining whether to playback a synopsis, as follows. FIG. 5 is a flowchart showing the process sequence and the process operations.

That is, the synopsis playback determination module 234 determines whether to playback synopsis data based on the past playback count of the corresponding content data. For example, the synopsis playback determination module 234 acquires the past playback count of the corresponding content data in step S61. This operation can be implemented by counting the playback count for each content data item, adding the count value to the content data, storing the count value in the content storage area 41 of the storage unit 4, and reading the count value from the content storage area 41. The acquired past playback count is compared with a predetermined threshold value in step S62. When the past playback count is equal to or more than the threshold value based on this comparison result, it is determined that the user probably appreciates the synopsis of the content data. The process advances to step S72, and it is determined that “synopsis data need not be played back”.

On the other hand, when the past playback count is less than the threshold value, the synopsis playback determination module 234 determines whether to playback the synopsis data based on the elapsed time after interruption of the corresponding content data. For example, in step S63, the synopsis playback determination module 234 reads information representing the interruption time of the corresponding content data from the internal memory 233, and calculates the elapsed time after interruption of the content data based on the interruption time and the current time obtained by the internal clock. Then, the synopsis playback determination module 234 compares the calculated elapsed time with the predetermined threshold value in step S64. When the elapsed time after interruption is less than the threshold value based on this comparison result, it is determined that the user probably remembers the content before interruption since the elapsed time is short. The process advances to step S72, and it is determined that “synopsis data need not be played back”.

On the other hand, when the elapsed time after interruption is equal to or more than the threshold value, the synopsis playback determination module 234 determines whether to playback the synopsis data based on the degree of preference (rate information) of the content data. For example, in step S65, the synopsis playback determination module 234 acquires information representing the degree of preference of the corresponding content data. This operation can be implemented by adding, to the content data, information (e.g., the number of stars) representing the degree of preference, i.e., the favorite level of the user for the content data, storing it in the content storage area 41 of the storage unit 4, and reading the information representing the degree of preference. The synopsis playback determination module 234 compares the read degree of preference with the predetermined threshold value in step S66. When the degree of preference is equal to or more than the threshold value based on this comparison result, it is determined that the user probably remembers the content. The process advances to step S72, and it is determined that “synopsis data need not be played back”.

On the other hand, when the degree of preference is less than the threshold value, the synopsis playback determination module 234 determines whether to playback the synopsis data based on the user's schedule data. For example, the synopsis playback determination module 234 reads the user's future schedule data from the schedule storage area 43 of the storage unit 4 in step S67, and determines in step S68 whether there is an event which causes the user to interrupt playback of the content data within a predetermined period of time in the future. When there is an event based on this determination result, it is determined that the user has insufficient time to playback the content data. The process advances to step S72, and it is determined that “synopsis data need not be played back”.

On the other hand, when there is no event within a predetermined period of time in the future, the synopsis playback determination module 234 determines whether to playback the synopsis data based on a time of the corresponding content data which is already played back, i.e., a played back time. For example, the synopsis playback determination module 234 acquires information representing the played back time of the corresponding content data in step S69. This operation can be implemented when the content playback control module 232 calculates the played back time for each content data item, adds the played back time to the corresponding content data, stores it in the content storage area 41 of the storage unit 4, and reads it. The synopsis playback determination module 234 compares the read played back time with the predetermined threshold value in step S70. When the played back time is equal to or more than the threshold value based on this comparison result, it is determined that the user probably remembers the content. The process advances to step S72, and it is determined that “synopsis data need not be played back”.

On the other hand, when the played back time is less than the threshold value, the process advances to step S71, and the synopsis playback determination module 234 determines that “synopsis data needs to be played back”. That is, when satisfying the five conditions, i.e., when (1) the past playback count is less than the threshold value, (2) the elapsed time after interruption is equal to or more than the threshold value, (3) the degree of preference is less than the threshold value, (4) there is no event within a predetermined period of time in the future, and (5) the played back time is less than the threshold value, it is determined that “synopsis data needs to be played back”.

When the synopsis playback necessity/nonnecessity determination process ends as described above, the control unit 23 then confirms in step S49 whether to playback the synopsis based on the determination result. When the synopsis is to be played back, the process advances to step S50, and the control unit 23 plays back the synopsis data under the control of the synopsis playback control module 235 as follows.

That is, the synopsis playback control module 235 first reads information representing the interruption time of the corresponding content data from the internal memory 233, and reads, from the synopsis storage area 42 of the storage unit 4, the synopsis data representing the synopsis of the content till the end of the chapter immediately before the chapter including the interruption time. The read synopsis data is supplied to the codec 22, and played back. For example, when playback is interrupted in the middle of the chapter CH3 of the content data as in shown FIG. 7, the synopsis data PD1-2 till the end of the chapter CH2 immediately before the chapter CH3 is selectively read and played back.

When playback termination of the synopsis data PD1-2 is detected in step S51, the synopsis playback control module 235 transmits the synopsis playback termination notification to the content playback control module 232. The content playback control module 232 reads, from the internal memory 233, information representing the interruption position of the content data in step S52, reads the content data from the interruption position based on the read information, and causes the codec 22 to playback the read content data.

After that, the control unit 23 repeatedly performs the control processes in steps S42 to S52 until the content data playback termination notification is detected in step S53. When the content data playback termination notification is detected in step S53, the mobile terminal returns to the standby state. In this manner, as shown in FIG. 7, the synopsis data PD1-2 is first played back after a speech communication period Ts, and the content data CD is sequentially played back from the interruption position. In this case, the content data CD may be played back from the beginning of the chapter CH3 which includes the interruption position.

When it is determined that “synopsis data need not be played back” in the synopsis data playback necessity/nonnecessity determination process, the control unit 23 skips playback of the synopsis data. The process advances to step S52, and the control unit 23 immediately restarts playback of the content data CD under the control of the content playback control module 232.

As described above, according to the first embodiment, when playback of the interrupted content data is to be restarted, the synopsis playback determination module 234 determines whether the past playback record (e.g., the playback count) of the content data is less than the threshold value, whether the elapsed time after interruption of the content data is equal to or more than the threshold value, whether the degree of preference is less than the threshold value, whether the schedule data contains the event information which causes the user to act within a predetermined period of time, and whether the played back time of the content data is equal to or more than the threshold value. Only when these conditions are satisfied, the synopsis data is played back prior to playback of the content.

Therefore, the synopsis data is played back only when it is determined that the user requests to playback the synopsis based on the plurality of conditions including a predetermined condition unique to the mobile terminal. Accordingly, it is not troublesome for the user when the user does not require playback of the synopsis data.

### Second Embodiment

According to the second embodiment of the present invention, synopsis data is prepared and stored for each chapter of content data. When the synopsis data is to be played back prior to restart of playback of interrupted content data, the synopsis data corresponding to the chapter immediately before the chapter including the interruption position of the content data is selectively read and played back.

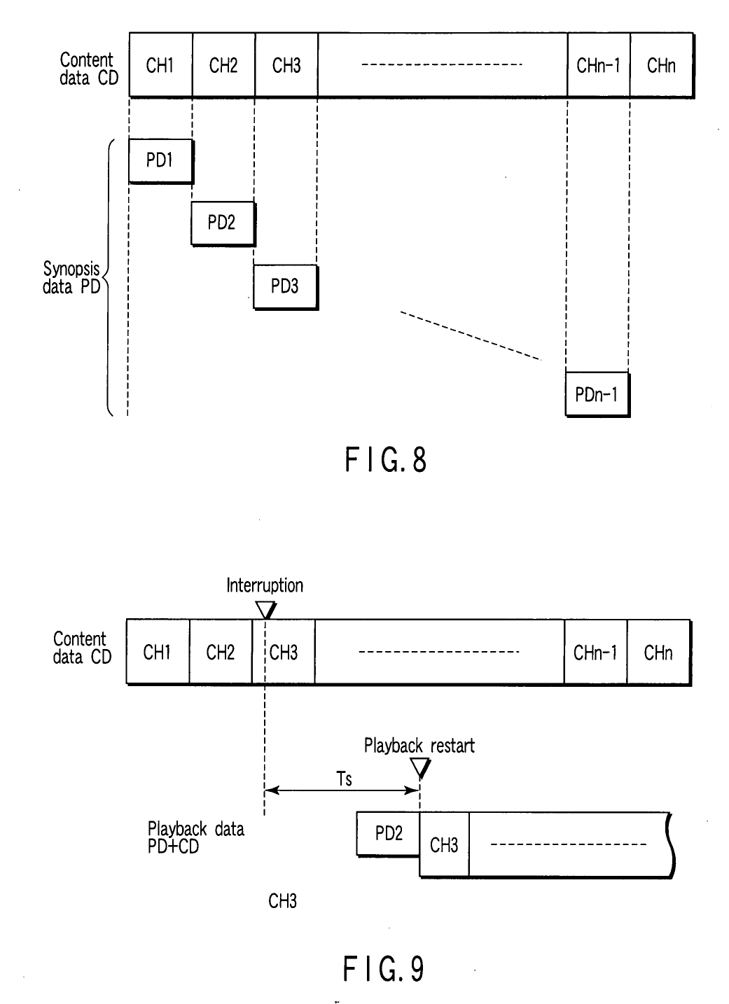

FIG. 8 shows an arrangement of content data CD and synopsis data PD which are handled by a mobile terminal according to the second embodiment of the present invention. Referring to FIG. 8, the content data CD is divided into a plurality of chapters CH1 to CHn, and synopsis data PD1 to PDn are generated in correspondence with the respective chapters CH1 to CHn. The content data CD and the synopsis data PD1 to PDn are downloaded from a Web site, and respectively stored in a content storage area 41 and a synopsis storage area 42.

When playback of interrupted content data is to be restarted, a control unit 23 executes the following processing. That is, referring to FIG. 9, assume that the playback of the content data CD is interrupted in the middle of the chapter CH3, and a speech communication time Ts has been elapsed. After that, when playback of the content data CD is to be restarted, the control unit 23 first determines whether to playback the synopsis data. This synopsis data playback necessity/nonnecessity determination process is executed following the same sequence and operations as shown in FIG. 5. When the synopsis data needs to be played back based on this determination result, the synopsis data PD2 corresponding to the chapter CH2 immediately before the chapter CH3 including the interruption position of the content data CD is selectively read from the synopsis storage area 42 of a storage unit 4. A codec 22 plays back the read synopsis data PD2. After completion of playback of the synopsis data PD2, the content data CD is sequentially read from the interruption position, and played back by the codec 22.

In this manner, referring to FIG. 9, the synopsis data PD2 is first played back after completion of the speech communication period Ts, and the content data CD is sequentially played back from the interruption position. In this case, the content data CD may be played back from the beginning of the chapter CH3 including the interruption position.

In such process, an increase in the information amount of the synopsis data can be effectively suppressed, thereby reducing the storage capacity of the synopsis storage area 42.

### Third Embodiment

According to the third embodiment of the present invention, one synopsis data of all chapters are stored for each content data. When the synopsis data is to be played back prior to restart of playback of the interrupted content data, the synopsis data representing the content of a predetermined time, which is obtained by tracing back the content data from an interruption position, is extracted from the stored synopsis data, and the extracted synopsis data is played back.

FIG. 10 shows an arrangement of content data CD and synopsis data PD which are handled by a mobile terminal according to the third embodiment of the present invention. Referring to FIG. 10, the synopses PD of all chapters are generated for each content data item CD. The content data CD and the synopsis data item PD are downloaded from a Web site, and respectively stored in a content storage area 41 and a synopsis storage area 42.

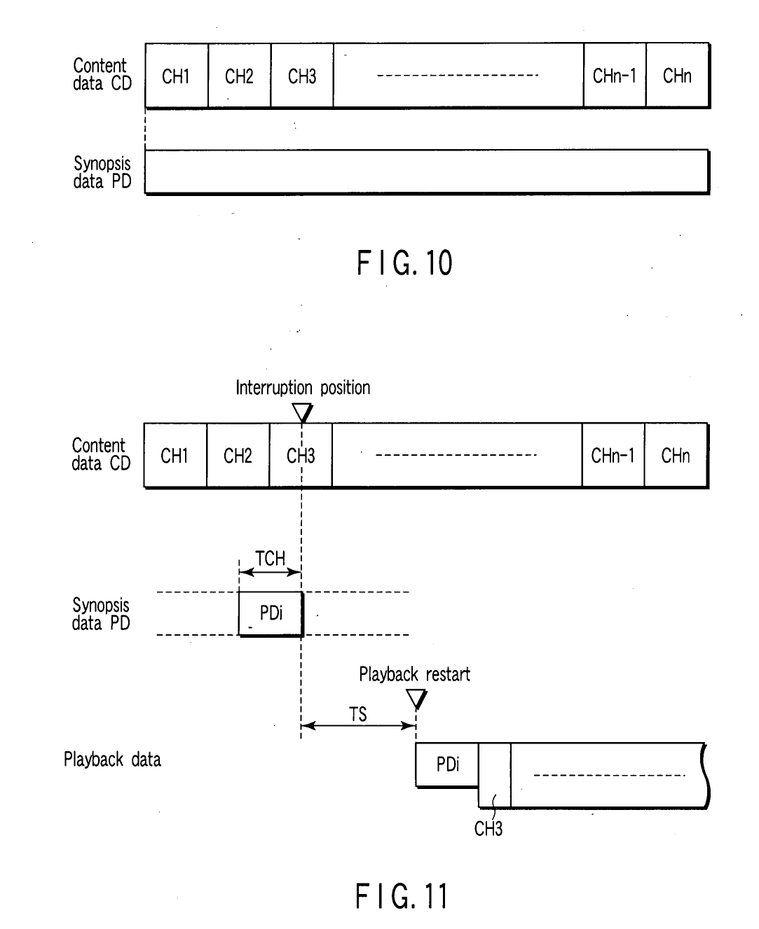

When playback of the interrupted content data is to be restarted, a control unit 23 executes the following processing. That is, referring to FIG. 11, assume that playback of the content data CD is interrupted in the middle of a chapter CH3, and a speech communication period Ts has been elapsed. After that, when playback of the content data CD is to be restarted, the control unit 23 first determines whether to playback the synopsis data similar to the first embodiment (FIG. 5).

When the synopsis data needs to be played back based on this determination result, synopsis data PDi representing the content data CD, which is obtained by tracing back the content data from the interruption position, is extracted from the synopsis data stored in the synopsis storage area 42, and played back by a codec 22. This synopsis data extraction process can be implemented by adding time stamps of all chapters in the synopsis data, which represent the positions of the chapters, and specifying the extraction position with the time stamps as guides.

After completion of playback of the synopsis data, the content data CD is sequentially played back from the interruption position in the chapter CH3.

As described above, according to the third embodiment, when the synopsis data needs to be played back, the synopsis data PDi representing the content data CD of a predetermined time, which is obtained by tracing back the content data from the interruption position, is extracted from the synopsis data of all chapters, and played back. Therefore, the synopsis data representing the content, which is obtained by tracing back the content data from the interruption position, can always be played back with any interruption position as a guide.

### Fourth Embodiment

The fourth embodiment of the present invention is implemented by improving the third embodiment. When synopsis data is to be played back, a time period between an interruption time and a playback restart time, i.e., an interruption period is calculated, and the length of the synopsis data to be played back can be set to be variable depending on the interruption period.

When it is determined that the synopsis data needs to be played back, a control unit 23 reads, from an internal memory 233, information representing the interruption time, and acquires the playback restart time from an internal clock to calculate the time period between the playback restart time and the interruption time, i.e., an interruption period Ts. Based on the obtained interruption period Ts, the control unit 23 calculates the playback time of synopsis data PD. The length of the playback time can be calculated by multiplying the interruption period Ts by a predetermined proportionality constant. Note that a memory table which represents the correspondence relationship between the interruption period Ts and the playback time may be prepared to read an optimal playback time corresponding to the interruption period Ts from this memory table.

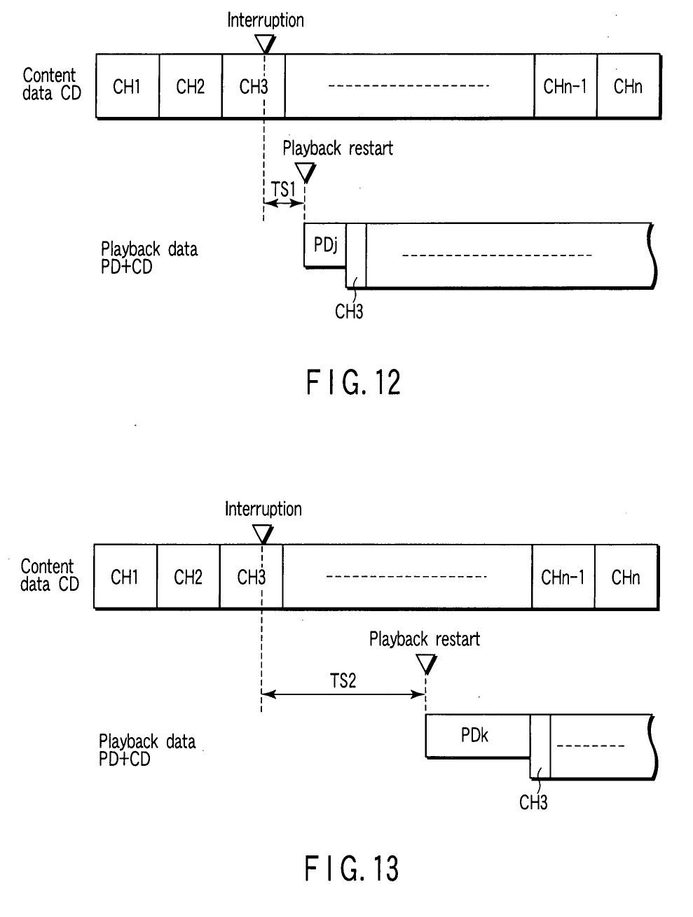

For example, referring to FIG. 12, when an interruption period Ts1 between the interruption time and the playback restart time is shorter than that in FIG. 11, the playback time of synopsis data PDj is set to be shorter than that of synopsis data PDi shown in FIG. 11 depending on the length of the interruption period Ts1. On the other hand, referring to FIG. 13, when an interruption period Ts2 between the interruption time and the playback restart time is longer than that in FIG. 11, the playback time of synopsis data PDk is set to be longer than that of the synopsis data PDi shown in FIG. 11 depending on the length of the interruption period Ts2.

In this manner, when the interruption period is long, the synopsis data of the relatively old content data is played back. Hence, the user can reconfirm the old content which tends to be forgotten because of the long interruption period. On the other hand, when the interruption period is short, only the synopsis data containing the relatively short content immediately before interruption is played back. Accordingly, it is not troublesome for the user to playback the synopsis data.

### Other Embodiments

In the first embodiment, synopsis data is played back only when the above-described five conditions (1) to (5) are satisfied. However, synopsis data may be played back when at least one of the five conditions (1) to (5) is satisfied.

In the above-described embodiments, the synopsis data prepared by a content producer or on a Web site is downloaded and stored in a storage unit 4. However, the present invention is not limited to this. The control unit of a mobile terminal may generate the synopsis data based on downloaded content data. When it is determined that the synopsis data needs to be played back, the synopsis data may be generated and played back based on the content before the interruption position of the content data at this time.

Also, various modifications may be made without departing from the spirit or scope of the general inventive concept, for the type and arrangement of a mobile terminal, the type of content data, the synopsis data, the playback control sequence and control procedures of the content data and the synopsis data, and the sequence and procedures of a synopsis data playback necessity/nonnecessity determination process.

Note that the present invention is not limited to the above embodiments, and can be variously modified and implemented without departing from the spirit and scope of the invention upon practice. Various inventions can be achieved by an appropriate combination of building components disclosed in the embodiments. For example, several building components may be omitted from all the building components described in the embodiments. Further, building components in different embodiments may be properly combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication apparatus comprising:
a storage unit configured to store content data;
a playback unit configured to playback the content data stored in the storage unit; and
a control unit connected to the storage unit and the playback unit,
the control unit configured to, if a playback request is input for the content data, control to read the content data from the storage unit, and control the playback unit to playback the content data,
if an interruption request is issued during playback of the content data, control to interrupt playback of the content data and control to store information representing an interruption position, and
if a playback restart request is issued for the interrupted content data and if the control unit determines that the synopsis needs to be played back based on a predetermined synopsis playback condition, control the playback unit to playback synopsis data corresponding to the content data before the interruption position, and control the playback unit to playback the content data from the interruption position.

2. The communication apparatus according to claim 1, wherein if the control unit determines that the synopsis need not be played back, the control unit is configured to the playback unit to playback the content data from the interruption position without playing back the synopsis data.

3. The communication apparatus according to claim 2, wherein
the control unit is configured to store a past playback record of the content data, and if the control unit determines the playback record is less than a predetermined threshold value, the control unit controls the playback unit to playback the synopsis data corresponding to the content data before the interruption position and controls the playback unit to playback the content data from the interruption position, and
if the control unit determines the playback record is not less than the threshold value, the control unit controls the playback unit to playback the content data from the interruption position without playing back the synopsis data.

4. The communication apparatus according to claim 2, wherein
the control unit is configured to calculate an elapsed time from an interruption time of the content data, and determines whether the obtained elapsed time is not less than a predetermined threshold value,
if the elapsed time is not less than the threshold value, the control unit controls the playback unit to playback the synopsis data corresponding to the content data before the interruption position and controls the playback unit to playback the content data from the interruption position, and
if the elapsed time is less than the threshold value, the control unit controls the playback unit to playback the content data from the interruption position without playing back the synopsis data.

5. The communication apparatus according to claim 2, wherein
if information representing a degree of user's preference is added to the content data stored in the storage unit,
the control unit determines whether the degree of preference of the interrupted content data is not less than a predetermined threshold value,
if the degree of preference is less than the threshold value, the control unit controls the playback unit to playback the synopsis data corresponding to the content data before the interruption position and causes the playback unit to playback the content data from the interruption position, and
if the degree of preference is not less than the threshold value, the control unit controls the playback unit to playback the content data from the interruption position without playing back the synopsis data.

6. The communication apparatus according to claim 2, wherein
if the storage unit stores information representing a user's schedule, the control unit determines whether a schedule to be executed by the user within a predetermined period of time in the future exists, based on the information representing the stored schedule,
if no schedule to be executed by the user within a predetermined period of time in the future exists, the control unit controls the playback unit to playback the synopsis data corresponding to the content data before the interruption position and controls the playback unit to playback the content data from the interruption position, and
if a schedule to be executed by the user within a predetermined period of time in the future exists, the control unit controls the playback unit to playback the content data from the interruption position without playing back the synopsis data.

7. A communication apparatus according to claim 2, wherein
the control unit is configured to calculate a played back time before interruption of playback of the content data, and determines whether the calculated played back time is not less than a predetermined threshold value,
if the played back time is less than the threshold value, the control unit controls the playback unit to playback the synopsis data corresponding to the content data before the interruption position and controls the playback unit to playback the content data from the interruption position, and if the played back time is not less than the threshold value, the control unit controls the playback unit to playback the content data from the interruption position without playing back the synopsis data.

8. The communication apparatus according to claim 2, wherein
the control unit controls the playback unit to playback the synopsis data corresponding to the content data of a predetermined time, which is obtained by tracing back the content data from the interruption position.

9. The communication apparatus according to claim 2, wherein the control unit calculates a period from a playback interruption time of the content data to a current time, and sets a playback time of the synopsis data to be variable depending on the obtained period.

10. The communication apparatus according to claim 2, wherein the control unit is configured to store the synopsis data corresponding to the content data stored in the storage unit, and controls to select data corresponding to the content data before the interruption position based on the stored synopsis data and controls the playback unit to playback the selected data.

11. The communication apparatus according to claim 2, wherein the control unit is configured to generate the synopsis data corresponding to the content data before the interruption position based on the content data stored in the storage unit, and controls the playback unit to playback the generated synopsis data.
